(19) United States
(12) Patent Application Publication
(10) Pub. No.: US 2010/0332970 A1
(43) Pub. Date: Dec. 30, 2010

(54) SYSTEM AND METHOD FOR CREATING AN ELECTRONIC DOCUMENT

(75) Inventors: CHUNG-I LEE, Tu-Cheng (TW); XIN-YU HUANG, Shenzhen City (CN); DONG-WEI JIN, Shenzhen City (CN); JIE HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,262

(22) Filed: Jun. 29, 2009

(51) Int. Cl. G06F 17/00; G06F 17/30

(52) U.S. Cl. 715/234; 707/802; 707/803; 707/822

(57) ABSTRACT

A method and system for creating an electronic document creates a blank electronic document, and then stores the blank electronic document into the computer according to a designated storage path and a filename. The method and system further receives parameters of template elements, extracts template elements according to the parameters from the storage device, and inserts the template elements into the blank electronic document according to the parameters to create an electronic document template.

### BACKGROUND

1. Technical Field

Embodiments of the present disclosure generally relate to systems and methods for inserting data into electronic documents, and more particularly to a system and method for automatically creating a completed electronic document.

2. Description of Related Art

With the development of the computer technology, use of office software is increasing in daily work. Word processing software may be used to create various contracts, forms, or any other documents that users need.

Usually, when creating a format contract using a word processing software, users may first manually create a contract template, such as a “Bill of Lading” template 2 illustrated in FIG. 1, and then manually insert data that is needed into the template contract to create completed contracts. However, manually creating a template is very time-consuming.

### BRIEF DESCRIPTION OF THE DRAWINGS

FIG. 1 illustrates an example of an electronic document template;

FIG. 2 is a block diagram of one embodiment of a system for creating an electronic document; and

FIG. 3 is a flowchart illustrating one embodiment of a method for creating an electronic document.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one

All of the processes described below may be embodied in, and fully automated via, function code modules executed by one or more general purpose computers or processors. The code modules may be stored in any type of computer-readable medium or other computer storage device. Some or all of the methods may alternatively be embodied in specialized computer hardware.

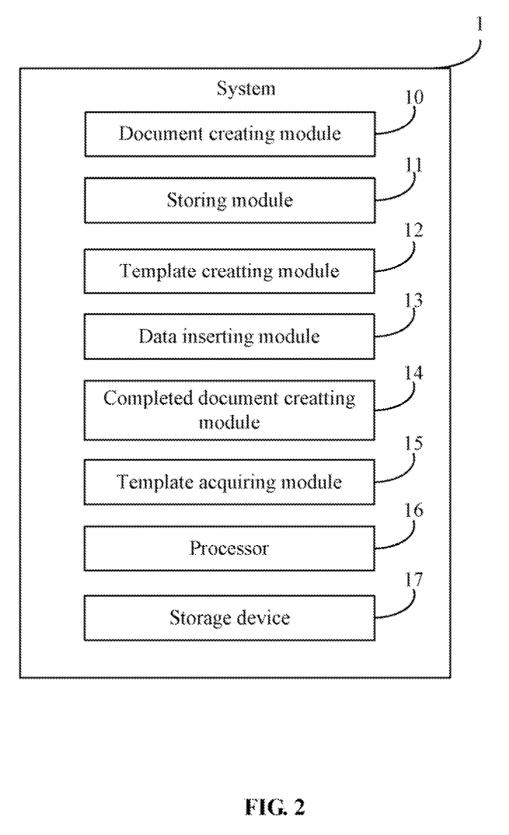

FIG. 2 is a block diagram of one embodiment of a system 1 for creating an electronic document. The system 1 may be, but is not limited to, a computer or an application server. In an embodiment, the system 1 includes a document creating module 10, a storing module 11, a template creating module 12, a data inserting module 13, and a completed document creating module 14.

One or more specialized or general purpose processors, such as a processor 16, in the system 1, may be used to execute the modules 10-14 to automatically create completed electronic documents. In addition, the system 1 may include a storage device 17, such as a hard disk drive or a floppy disk drive, which can store data needed in creating electronic documents. In one embodiment, one or more computerized code of the modules 10-14 may be stored in the storage device 17, and be executed by the processor 16.

The document creating module 10 is operable to create a blank electronic document. In one embodiment, the electronic document may be a word processing document or a spreadsheet, for example.

The storing module 11 is operable to designate a storage path and a filename for the blank electronic document, and store the blank electronic document into the storage device 17 according to the designated storage path and the filename. For example, the storage path may be designated as “D:\files” and the filename as “document.doc”, thus, the blank electronic document can be stored into the folder “files” in the disk D with the filename “document”.

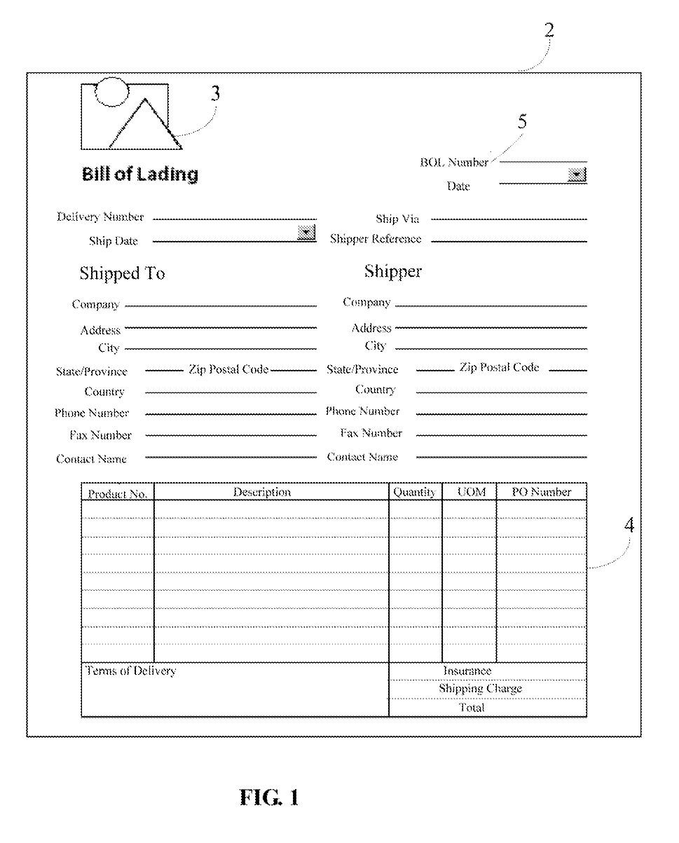

The template creating module 12 is operable to receive parameters of template elements, extract the template elements according to the parameters from the storage device 17, and insert the template elements into the blank electronic document according to the parameters to create an electronic document template. The template elements may include, but are not limited to, pictures, such as a picture 3 illustrated in FIG. 1, and/or tables, such as a table 4 illustrated in FIG. 1, and/or characters, such as “BOL Number” 5 illustrated in FIG. 1, and so on. The parameters may include, but are not limited to, element names, element paths, and inserting positions of the template elements, for example. Using the element names and the element paths, the template creating module 12 can acquire the template elements from the storage device 17. The inserting positions indicate where the template elements will be inserted into the blank electronic document. The template creating module 12 is further operable to save the electronic document template in the storage device 17 according to the designated storage path and the filename.

The data inserting module 13 is operable to acquire data to be inserted into the electronic document template from the storage device 17, and insert the data into correct positions of the electronic document template.

The completed document creating module 14 is operable to create a completed electronic document, which has the template elements and the data filled in the correct positions, and save the completed electronic document into the storage device 17.

In one embodiment, the system 1 may further include a template acquiring module 15 which is operable to acquire an existing electronic document template by receiving a filename and a storage path if the existing electronic document is previously stored in the storage device 17 for using by the data inserting module 13 and the completed document creating module 14 to create a completed electronic document including data filled in the correct positions.

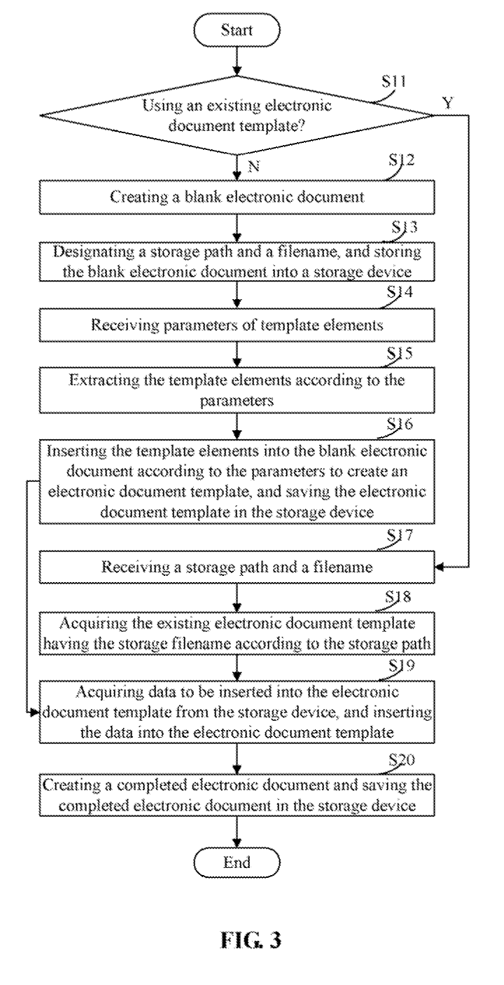

FIG. 3 is a flowchart illustrating one embodiment of a method for creating an electronic document in a computer. Depending on the embodiment, additional blocks in the flow of FIG. 3 may be added, others removed, and the ordering of the blocks may be changed.

In block S11, a determination is made as to whether an existing electronic document template can be used. The determination may be made by a user, for example, where the user can manipulate one or more control elements of the system 1 to select an existing electronic template. If there is at least one electronic document template in the storage device 17, and the user wants to use the existing electronic document template, then the procedure goes to block S17 described below. Otherwise, if the user does not want to use the existing electronic document template, the procedure goes to block S12.

In block S12, the document creating module 10 creates a blank electronic document. In one embodiment, the electronic document may be a word processing document or a spreadsheet, for example.

In block S13, the storing module 11 designates a storage path and a filename for the blank electronic document, and stores the blank electronic document into the storage device 17 according to the designated storage path and the filename. As mentioned above, if the storage path is designated as “D:\files” and the filename as “document.doc”, the blank electronic document is stored into the folder “files” in the disk D with the filename “document”.

In block S14, the template creating module 12 receives parameters of template elements. As mentioned above, the template elements may include pictures, tables, and characters, and the parameters may include element names, element paths, and inserting positions of the template elements.

In block S15, the template creating module 12 extracts the template elements from the storage device 17 according to the parameters.

In block S16, the template creating module 12 inserts the template elements into the blank electronic document according to the parameters to create an electronic document template, and save the electronic document template in the storage device 17 according to the designated storage path and the filename.

In block S19, the data inserting module 13 acquires data to be inserted into the electronic document template from the storage device 17, and inserts the data into correct positions of the electronic document template.

In block S20, the completed document creating module 14 creates a completed electronic document which has the template elements and the acquired data in the correct positions, and saves the completed electronic document into the storage device 17.

If in block S11, the user wants to use an existing electronic document template which has been stored in the storage device 17, then the procedure directly goes to block S17, in which, the template acquiring module 15 receives a storage path and a filename of the existing electronic document template.

In block S18, the template acquiring module 15 acquires the existing electronic document template according to the received filename and the storage path. After block S18, the process goes to block S19 described above.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for creating an electronic document in a computer having a storage device, the method comprising:
(a) creating a blank electronic document;
(b) designating a storage path and a filename for the blank electronic document and storing the blank electronic document into the storage device according to the designated storage path and filename;
(c) receiving parameters of template elements, wherein the parameters comprise element names, element paths, and inserting positions of the templates elements;
(d) extracting the template elements from the storage device and inserting the template elements into the blank electronic document according to the parameters to create an electronic document template; and
(e) saving the electronic document template in the storage device according to the designated storage path and filename.

2. The method as described in claim 1, wherein the electronic document is a word processing document or a spreadsheet.

3. The method as described in claim 1, wherein the template elements comprise pictures, tables, and/or characters.

4. The method as described in claim 1, further comprising:
acquiring data to be inserted into the electronic document template from the storage device, and inserting the data into correct positions of the electronic document template; and
creating a completed electronic document which is filled with the template elements and the acquired data, and saving the completed electronic document into the storage device.

5. A storage medium having stored thereon instructions that, when executed by a processor, causing the processor to perform a method for creating an electronic document, wherein the method comprises:
(a) creating a blank electronic document;
(b) designating a storage path and a filename for the blank electronic document and storing the blank electronic document into a storage device according to the designated storage path and filename;
(c) receiving parameters of template elements, wherein the parameters comprise element names, element paths, and inserting positions of the templates elements;
(d) extracting the template elements from the storage device and inserting the template elements into the blank electronic document according to the parameters to create an electronic document template; and
(e) saving the electronic document template in the storage device according to the designated storage path and filename.

6. The storage medium as described in claim 5, wherein the electronic document is a word processing document or a spreadsheet.

7. The storage medium as described in claim 5, wherein the template elements comprise pictures, tables, and/or characters.

8. The storage medium as described in claim 6, wherein the method further comprises:
acquiring data to be inserted into the electronic document template from the storage device, and inserting the data into the electronic document template; and
creating a completed electronic document which is filled with the template elements and the acquired data, and saving the completed electronic document into the storage device.

9. A system for creating an electronic document, comprising:
a storage device;
a document creating module operable to create a blank electronic document;
a storing module operable to designate a storage path and a filename for the blank electronic document, and store the blank electronic document into the storage device according to the designated storage path and the filename;
a template creating module operable to receive parameters of template elements, wherein the parameters comprise element names, element paths, and inserting positions of the templates elements, further operable to extract the template elements according to the parameters from the storage device, and insert the template elements into the blank electronic document according to the parameters to create an electronic document template; and
a processor that executes the document creating module, the storing module, and the template creating module.

10. The system as described in claim 9, further comprising:
a data inserting module operable to acquire data to be inserted into the electronic document template from the storage device, and insert the data into the electronic document template; and
a completed document creating module operable to create a completed electronic document, and save the completed electronic document into the storage device.

11. The system as described in claim 9, wherein the storage device is a hard disk drive or a floppy disk drive.

12. The system as described in claim 9, wherein the electronic document is a word processing document or a spreadsheet.

13. The system as described in claim 9, wherein the template elements comprise pictures, tables, and/or characters.
